(19) United States
(12) Patent Application Publication
(10) Pub. No.: US 2002/0069176 A1
(43) Pub. Date: Jun. 6, 2002

(54) System for obtaining fee-based data and services

(76) Inventor: Daniel Newman, Seattle, WA (US)

Correspondence Address: FITZPATRICK CELLA HARPER & SCINTO, 30 ROCKEFELLER PLAZA, NEW YORK, NY, 10112, US

(21) Appl. No.: 09/729,815

(22) Filed: Dec. 6, 2000

(51) Int. Cl. G06F 17/60

(52) U.S. Cl. 705/53; 705/52; 705/26; 705/40

(57) ABSTRACT

A system and method that enables a user to access content data over a network by retrieving information from a provider via the network. A determination is made whether the content data requires payment of a fee by the user. If the content data requires a fee, a determination is made whether payment for the content data has been pre-approved by user-defined parameters. If the fee has been pre-approved by the user, the user incurs a charge for the content data. The content data is displayed to the user and the fees are accumulated by a third party provider. The third party provides pays the content provider the amount of the accumulated fees and the user makes payment to the third party provider. The method and system is also used to provide payment of royalties for content retrieved from a network and to purchase items advertised over a network, such as the Internet.

### BACKGROUND

1. Field of the Invention

This invention relates generally to retrieving and paying for content data, goods and/or services from a remote location. More particularly, this invention relates to accumulating small, incremental fees for the content data, goods and/or services, wherein the fees are collected on a periodic basis.

2. Background Art

Fees for Internet services can be collected through a credit card system, as some vendors currently do. However, this is a cumbersome way to account for a series of small, repeated and incremental costs. Credit cards are not well-suited for processing numerous charges for fractions of a dollar. New “cashless” or “e-wallet” systems attempt to replace the credit card and also inherit its disadvantages.

Internet services are either offered for free, often at a net loss by the vendor, or on a full subscription basis, without an efficient way to charge for individual use. There are very few vendors offering smaller services and information on a pay-per-use basis, with the lack of a convenient mechanism for so doing as the primary obstacle. Convenience is a central concern in transactions over the Internet, and the time necessary to process and verify a small charge, for example a charge between one-cent and two dollars, either to a credit card or a credit card substitute, is sufficiently cumbersome to impede payment transactions over the Internet.

Non-Internet based systems have found ways around this dilemma, and seek to make the process as simple as possible for both user and vendor. For example, telephone companies provide enhanced telephone services, such as last-call-return and directory assistance. The telephone company accumulates charges incurred by user toward an existing bill, rather than requiring the user to provide credit card information necessary for a small charge, such as fifty cents.

Many industries face the barrier of simple accumulation of fees from a remote location. For example, to obtain a copy of a patent from, for example, the Delphion website, a user must navigate through a cumbersome process to pay a three dollar fee for the content.

U.S. Pat. No. 5,692,132, issued to Hogan, relates to purchasing items or carrying out transactions of relatively small monetary value. The amount of the transaction is deducted from the balance on the computer. When the existing balance associated with the computer does not cover the price of the transaction, the system provides a reload feature that gives the user an option to increase the balance on the computer Such a feature allows the purchase to be made without inconveniencing the user to increase the balance by other means. Each time the balance is increased by a reload, the user's issuer bank bills the user for the reload amount. Unfortunately, this system is a debit-based system that is tied to a single computer, without the ability of remote access. Another drawback is that there is no means to adjust automatic acceptance by service, time, or amount.

U.S. Pat. No. 5,930,777, issued to Barber, relates to a method of charging for pay-per-access information over a network. A banker mints tokens identified with particular information that a consumer may wish to purchase. The tokens are preauthorized for a consumer to pay for a particular page of information. The tokens are expressly identified with particular information, and accepted by agreement between the banker and the vendor. A drawback to Barber is that there is no provision for the user to set flexible parameters to govern use of the tokens. A second drawback with the system disclosed in Barber is that it operates with an initial gateway for fee-based information, a front door Web page that precedes fee-based data. This requires that sites group their fee-based data beyond such a portal, and that a user sign in, with a password, for admittance upon each encounter. A third drawback is that the system disclosed in Barber works solely on a debit basis, precluding credit bundling by an ISP, a telephone company, or any other provider.

U.S. Pat. No. 6,058,381, issued to Nelson, relates to a payment method for network transactions in merchandise between purchasers and vendors. Guarantors issue vouchers for payment.

What is needed is a system that enables users to retrieve selected services and/or content data as seamlessly as they may currently retrieve those provided without charge, while accumulating to the service and/or content providers the many small fees that are paid on a periodic basis.

### SUMMARY OF THE INVENTION

The present invention relates to a method and apparatus that allows a user to decide the types of service and/or content to be accepted without interruption. The present invention also enables a user to retrieve services and/or content data from a plurality of remote locations and accumulate fees that are paid to the content provider in larger payments.

Accordingly, one embodiment of the present invention is directed to a method that enables a user to access content over a network. This method includes retrieving content data from a content provider via the network. Next, it is determined whether the content requires payment of a fee by the user. If payment for the content has been pre-approved by user-defined settings, the user incurs a charge for the content. The content is then displayed to the user. A plurality of fees incurred by the user are accumulated at a third party provider and the third party provides pays the content provider the amount of the accumulated fees. The user then makes payment to the third party provider.

Furthermore, the user-defined settings can be integrated on a browser application.

Another embodiment is directed to a system that enables a user to retrieve fee-based content data from a remote location. The system includes a client information appliance that retrieves content data to a user from a remote location based on user-defined settings. A content provider appliance, provides content data from a content provider to one or more client information appliances. The client information appliance determines whether the content data requires payment of a fee and if so determines whether the content has been pre-approved. A payment appliance accumulates fees incurred by a user and remits payment to the content provider.

Another embodiment is directed to an apparatus and method that enables a user to retrieve a sample portion of data, and based on that sample, retrieve content that requires payment. In this embodiment, the user retrieves a free sample, such as an abstract. It is then determined whether the content requires payment of a fee by the user. Next, it is determined whether additional content is to be displayed, based on the retrieved portion. The additional content is displayed to the user and all of the fees for the content data are accumulated at a third party provider. The third party provides pays the content provider the amount of the accumulated fees and the user makes payment to the third party provider.

Yet another embodiment is directed to an apparatus and method that enables an artist or creator of work to collect a royalty payment when a user retrieves such work. In this embodiment, a user retrieves selected content data (typically a first portion of the selected content data is provided without charge and the user then determines whether a second portion, that has an associated fee is desired). When the selected content data is retrieved, the associated charge is calculated. Payment of a royalty is made to the artist or creator, either directly or indirectly and payment is made to the content provider on a periodic basis.

Yet another embodiment is directed to an apparatus and method that enables a user to access content and make purchases over a network. The method includes a user pre-authorizing a first fee amount for content data and the user pre-authorizing a second fee amount for items or services. Content data is retrieved from a content provider via the network and it is determined whether payment for the content has been pre-approved by user-defined settings. If the content has been pre-approved by the user-defined settings the user incurs a charge for the content. The content data is displayed to the user and typically includes one or more offers for items or services. Content-related fees incurred by the user are accumulated at a third party provider. The user may then select an item or service, which has an associated fee. A determination is made whether payment for the item or service has been pre-approved by user-defined settings. If payment for the item or service has been pre-approved by the user-defined settings the user incurs a fee for the item or service. The third party provider pays the content provider the amount of the accumulated fees, both for content data and item or services. The user makes payment to the third party provider.

### BRIEF DESCRIPTION OF THE DRAWINGS

FIG. 1 shows one embodiment of the present invention.

FIG. 2 shows a user appliance according to the present invention.

FIG. 3 shows a second embodiment of the present invention.

FIGS. 4A and 4B show a first flowchart of steps to implement the present invention.

FIGS. 5A-5C show a second flowchart of steps to implement the present invention.

FIGS. 6A-6B show an embodiment of paying a royalty for retrieved data.

FIG. 7 shows an embodiment of retrieving content data and then purchasing an item or service.

### DETAILED DESCRIPTION

The instant invention is directed to a system in which a user applies user funds that are credited or debited to a user account. The instant invention has the advantage that the user funds accomplish what credit cards cannot: processing incremental costs efficiently in a manner that makes for simple use of fee-based Internet services and products. User funds of the present invention may be carried on either a credit basis, which means the user will pay for transactions at a future date, or a debit basis, which means debiting funds the user has already purchased from a third party. The present invention broadens the ways in which a vendor may offer more fee-based services, especially over a network, such as the Internet.

An aspect: of the present invention is directed to efficient payments through an automatic system, handled by a third party provider, for fee-based transactions over the Internet. The system works on either a credit- or debit-based agreement, and it is particularly adept at handling numerous small incremental fees, or charges. This enables services and products currently unavailable due to lack of a convenient method of payment to be offered. This system provides a way to account for, and pay for, incremental charges while using networks, such as the Internet, so that browsers may be used to access fee-based services and content as conveniently as they currently do for services and products, such as content data, that are free. A user “pre-authorizes” payment, so user funds are not merely pre-authorized for a consumer to pay for access for a particular page of information; rather, they are funds available for access to any goods or services, retrieved automatically or by prompt, at the discretion of the user.

The present invention automatically handles small charges and processes them through a third party provider. The third party provider manages user funds. The third party provider does not need to be a financial institution, although banks and brokerage houses are some examples. The third party provider could also be an Internet Service Provider or a cable company or a phone company, that may elect to offer the system on a credit basis, combining any charges with customer bills already issued. The system is typically integrated into the user's web browser, so that the act of selecting a fee-based product or service initiates the process. It is possible to maintain a user balance with the third party provider rather than storing the user balance on the user's computer. This is more secure, and it allows the user to draw from the account from any computer, rather than having the funds fixed to a single unit.

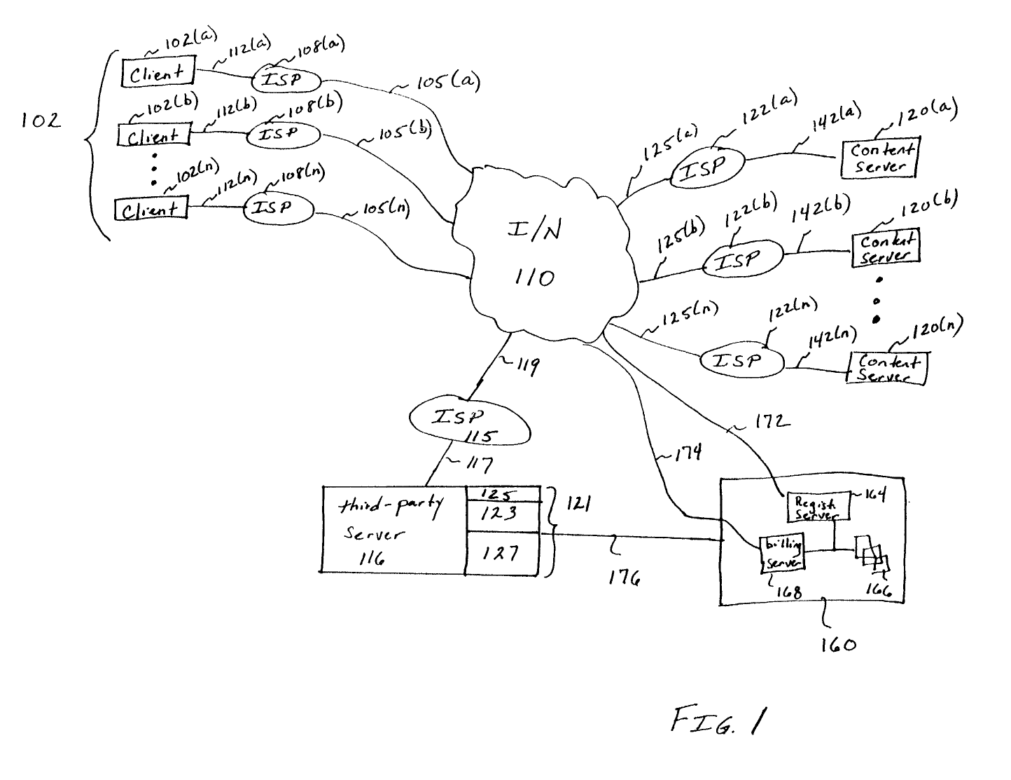

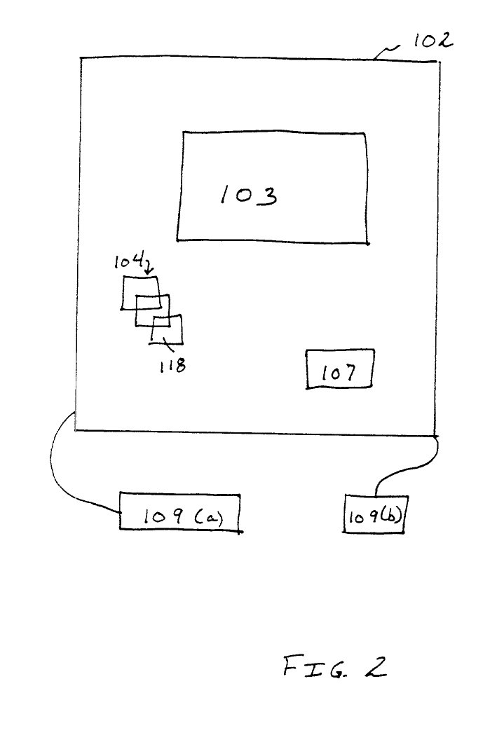

FIG. 1 shows one embodiment of the present invention. The system 10 includes a plurality of client information appliances 102, network 110, third party server 116, content provider information appliances 120 and billing information appliance 160.

The individual client information appliances 102 may include, for example, PC's, portable PC's with docking nodes, web TV's, cable system set top boxes, handheld personal digital assistants with wireless capability, cellular phones, pagers, and the like. Information appliances 102 can access an Internet service provider (ISP) directly, or via a network connection, which can be telephone, cable, or other wireless systems. In general, the teaching of this invention may be employed in conjunction with any suitable type of information appliance device 102 that is capable of communicating with other components of a communication system/network, and that includes one or more user interfaces for enabling a user to input information, view or otherwise perceive presented (e.g., displayed) information, and select or otherwise manipulate such presented information.

As described above, each of client information appliances 102(a) . . . 102(n) (where n may be any number) may be, for example, a commercially available general purpose computer such as a windows-type or MacIntosh-type computer, equipped with a desktop browser that enables the user to “surf the Net”. Each client information appliance 102 has an associated communications link 112 to connect the client information appliance 102 with an associated Internet Service Provider (ISP) 108, or Internet Access Provider (IAP). An ISP is typically a company providing access to the Internet, generally for a monthly fee. All Internet traffic from its users are initially routed through its sites. Some of the largest ISPs, including AOL and CompuServe, provide users with their proprietary browsers.

Alternatively, a local area network (LAN), local exchange carrier (LEC), Digital Subscriber Line (DSL) or Integrated Services Digital Network (ISDN), or cable, or a wireless or other format of data exchange could be used.

In FIG. 1, each client information appliance 102 is depicted as being connected to a unique ISP; plainly it is equally possible, and will often be the case, that several client information appliances are connected to the same ISP. Communication links 105 connect the ISPs 108 to the network 110. Each client information appliance 102, through its ISP 108, can transmit data to and receive data from the network 110, in ways that will be readily apparent to those skilled in the art.

Network 110 is any network of inter-connectable computers. In the present invention, network 110 preferably is the Internet with World-Wide-Web capabilities. The World-WideWeb provides access to Internet information and services by using hypertext to organize, search and present information to a user.

Third party server 116 is connected to the Internet 110 via Internet Service Provider 115 and communication links 117 and 119. The server 116 is for example, a computer or group of computers that facilitate the transmission, storage, and reception of such information and other data between different points, such as between components, and between external sources/destinations.

The third party server 116 stores user account information. The account information is typically stored in memory 125 and is typically balance information relating to user funds that a user has deposited, a credit card account number, debit card account number or billing information to bill a user for fees accumulated by the user when a user retrieves data from a content provider location.

From a hardware standpoint, in this disclosure a server computer, such as server 116, will typically include one or more components, such as one or more microprocessors (also referred to as “controllers”) (not shown), for performing the arithmetic and/or logical operations required for program execution. A server computer will also typically include disk storage media 123 (also referred to as a “memory”), such as one or more disk drives for program and data storage, and a random access memory, for temporary data and program instruction storage 127.

From a software standpoint, a server computer also contains server software (not shown) resident on the disk storage media 123, which, when executed, directs the server computer in performing its data transmission and reception functions. The server software runs on an operating system, for example Windows 2000 Advanced Server™ (Microsoft Corporation, Redmond Washington), which is also stored on the disk storage media. Server computers are offered by a variety of hardware vendors, can run different operating systems, and can contain different types of server software, each type devoted to a different function, such as handling and managing data from a particular source, or transforming data from one format into another format.

The server 116 and the associated memories 123, 125 and 127, collectively referred to as 121, store various operating programs and routines for controlling server operations. In a preferred embodiment, one of the programs stored in memory 121 is web server software, preferably Microsoft Internet Information Server (“IIS”) (or later versions thereof), running on a Windows platform. Also in the preferred embodiment, another program stored in the memory 121 is Microsoft Exchange 2000 (or later versions thereof).

Third party server 116 contains a stored program that generates web site data that, when displayed on client information appliances 102, permits the user to select and pay for content-data from a remote location.

The web site data, or content data, are delivered across the Internet 110 to users' browser programs. The third party server 116 receives electronic information from client information appliances 102 regarding billing information from a user. A user, after receipt of an abstract or sample of data, may elect to pay for a full version or additional content of the sampled data. The sample or abstract is typically provided without cost or obligation to the user. The content provider sites permit a user to make purchases of content data. The purchases are preferably done by a user sending a credit card account number or bank account number, which are encrypted prior to transmission, to the third party server 116. Known encryption techniques, such as SSL (secure sockets layer), PGP (pretty good privacy) and Envelop98, can be used to ensure the security of the credit card or bank account information transmitted over network 110.

Alternatively, an additional client module could be used as the third party server 116 with associated memory 121. In such an embodiment, the functions of the third party provider would be carried out by another client module.

Billing appliance 160 includes a billing registration server 164, billing server 168 and memory 166. Billing registration server 164 is connected to network (Internet) 110 via communication link 172. Communication link 176 connects the billing server 168 to third party transaction server 116. Communications link 174 connects the billing server 168 to Internet 110. The billing information appliance 160 can use information obtained by the third party transaction server 116 to generate billing information for users who have indicated that they would like to purchase particular content-data.

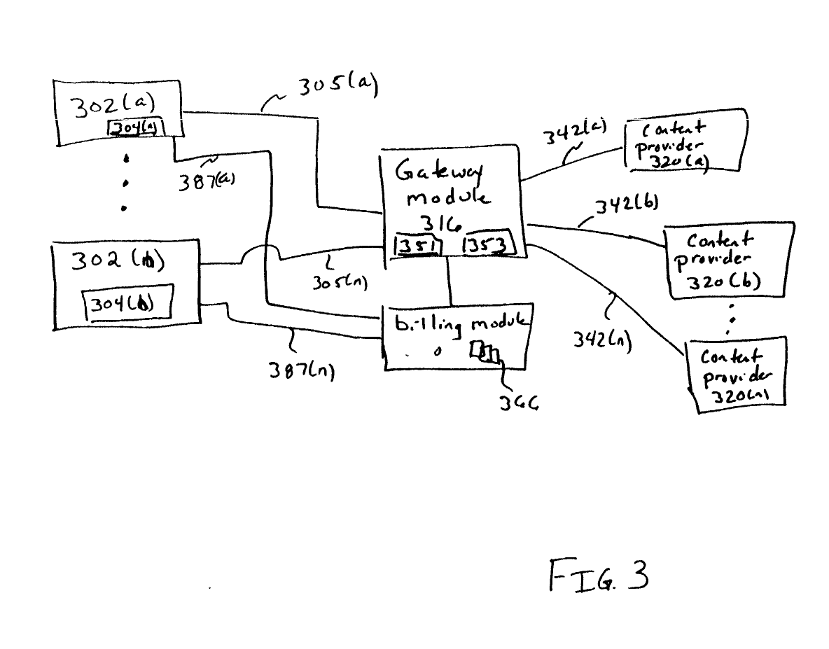

Upon activation of an account, the billing server 168 preferably assigns and deposits a “cookie”, which is information from a given web site stored on a user's computer, in the browser program (browser shown in FIG. 2 as 118) running on client information appliance 102, which in turn transmits it back to the billing information appliance 160 during the course of a transaction. Thus, when a user clicks (uses an input device to access a computer program function) on an icon of the web site, representing an intent to purchase selected content-data, the information stored in the cookie file on the client information appliance 102 is transmitted to billing information appliance 160.

The billing information appliance stores the fees incurred by a user. The fees incurred by a user can be paid to the content provider in one currency and billed to the user in a second currency. This enables a content provider to be paid in a currency that they desire and the user to make payment in a currency that the user desires. The billing information appliance stores exchange rates in memory such that the rates may be updated on a periodic basis. For example, the exchange rates between currencies can be updated at the start of each business day according to a particular published exchange rate. The use makes payment on a periodic basis, which can be prespecified, such as every month, every three months, or other period.

Alternatively, the third-party provider may store all relevant information in its own databases, either for security or to allow any user to access the system from a remote location. The third party provider can also store exchange rate data and calculate the fees in a variety of currencies.

FIG. 1 also shows content provider servers 120(a), 120(b) . . . 120(n) (where n may be any suitable number). Content provider servers 120 are computers, similar to third party server 116, discussed above, which include web pages that transmit information from a content provider over network 110 to client information appliances 102. The transmitted information can include content data that is transmitted for a fee to a user information appliance 102. The content data can also be free, that is no fee or charge is incurred when a user downloads it to a client information appliance 102.

Internet Service Provider (ISP) 122(a), 122(b) . . . 122(n) and communication links 142(a), 142(b) . . . 142(n) and 125(a), 125(b) . . . 125(n) provide access from the Internet 110 to content provider servers 120(a) . . . (n), respectively. The content provider servers 120 provide content data to user information appliances 102.

The content data retrieved by user information appliance 102 is typically web page data. Web pages are combinations of text and tags in a coding system such as Hypertext Markup Language (HTML), which are typically stored on content provider servers and then delivered across the networks to user's browser programs. The HTML tags serve a number of functions. Some mark portions of the text control how the user's browsers will format text before it is viewed. Other HTML tags represent pieces of additional content that is retrieved and brought to the browsers. This information can be compiled into web pages before a user views them.

Static elements, such as standard text may be stored directly as text in the HTML source text, while other elements, like images and music may all be stored in separate files on the same server or they may be stored at remote geographic locations on separate servers.

HTML tags can be used to bring pictures, movie or video content, sound content, text or any combination thereof to a web page.

Web developers can use a computer program, such as Java™ to create dynamic, real-time web pages to display information. Java™ supports programming on the Internet in the form of platform-independent Java applets, which are small, specialized applications that comply with Sun Microsystems Java Application Programming Interface (API) allowing developers to add interactive content to web documents. Applets execute within a Java-compatible browser (e.g. Netscape Navigator™) by copying code from the server to the client information appliance.

Alternatively, products from Microsoft™ such as ActiveX™ enable developers and web designers to build dynamic content for a web site. For example, ActiveX Controls, which are small, fast components, enables developers to embed parts of software in hypertext markup language (HTML) pages. ActiveX Controls™ work with a variety of programing languages including Microsoft Visual C⁺⁺ and C^{#}, Borland Delphi, Microsoft Visual Basic and future versions thereof.

Hypertext Transfer Protocol (HTTP) manages the interchange between browsers, that retrieve web page content, and the servers that provide web page content. HTTP permits following a Uniform Resource Locator (URL) address by the browser to an address on the server.

FIG. 2 shows the components of an embodiment of a client information appliance 102. These components include an output user-interface 103, a memory 104, a browser 118, a processor 107 and an input devices 109(a) and (b).

Examples of suitable input devices 109(a) and (b) include a keyboard, a mouse, voice-input device, a trackball, touch screen, and/or any other suitable type of user-operable input device(s).

The output user-interface 103 may include, for example, a video display, a liquid crystal or other flat panel display, a speaker, a printer, and/or any other suitable type of output device for enabling a user to perceive outputted information.

The memory 104 may include any suitable storage device or storage devices, such as for example a hard drive, a zip drive, a CD-ROM drive, disk drive, etc., and will store an Internet browser on 118, as well as other software programs commonly found on a personal computer (such as, for example, conventional operating systems and Internet browsers). A browser program is typically a computer application for navigating the Internet and exchanging information. These include general browsers, such as Microsoft Internet Explorer and Netscape Navigator, as well as the proprietary ones offered by some Internet Service Providers, including AOL and CompuServe. Examples of suitable Internet browsers 118 include the Microsoft Internet Explorer™ browser and the Netscape™ T browser. Other operating systems and Internet browsers are plainly possible as well.

The processor 107 might include any commercially available processors, such as Intel processors currently, such as the Intel Pentium™ processors currently equipped in IBM™ or IBM™-type personal computers, or the Motorola™ processors currently equipped in MacIntosh™ computers.

As will be apparent to those skilled in the art, user information appliance 102 could be connected to other devices such as a printer, other computer, or audio output device, such as a speaker.

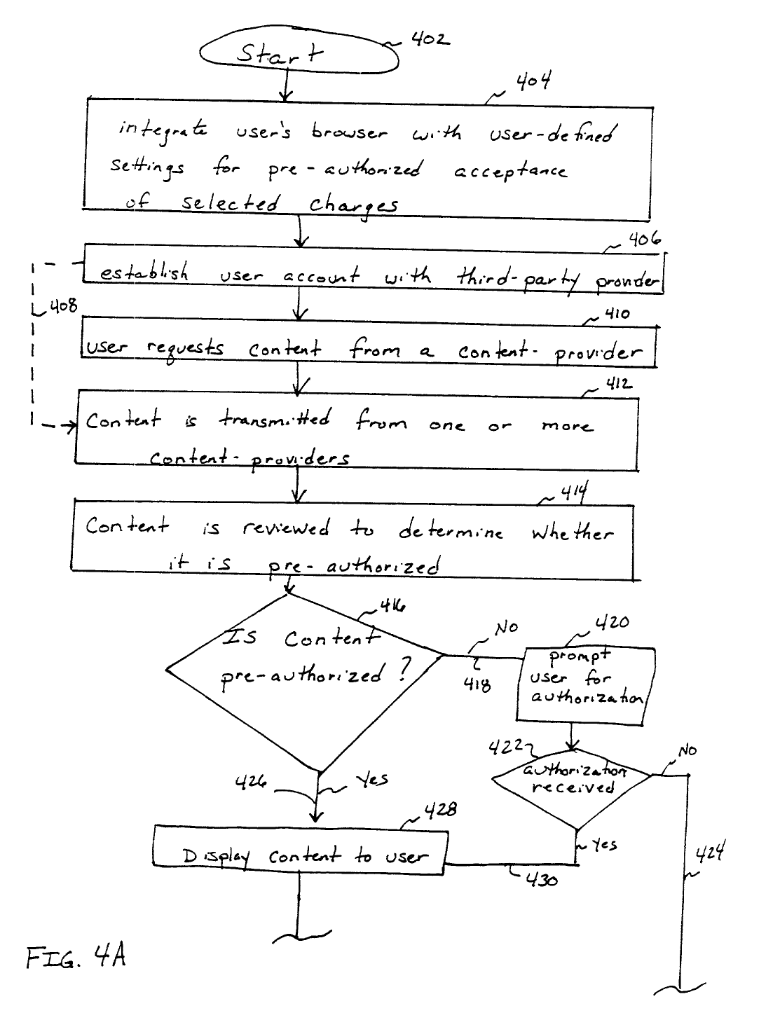

FIG. 3 shows a second embodiment 30 of the present invention that does not utilize the Internet. A gateway module 316 connects client modules 302(a) . . . (n), billing module 360 and content provider modules 320 (a) . . . (n) where n is any suitable number.

The gateway module 316 includes memory 351 and is coupled to client modules 302(a) . . . (n) via communication links 305(a) . . . (n), respectively. Communication links 305 can be electrically conductive wires or paths, photoconductive lines, infrared or wireless transmission. The gateway module 316 is also coupled to content provider modules 320(a) . . . (n) via communication links 342(a) . . . (n), respectively. Communication links 342 can be of the same type as communication links 305. The gateway module 316 is coupled to billing module 360 via communication link 377. The client modules 302(a) . . . (n) are coupled to billing module 360 via communication links 387(a) . . . (n), respectively.

The client modules 302 are similar to client information appliances discussed in relation to FIG. 1.

The billing module 360, with memory 366, is similar to the billing appliance 160 described in FIG. 1.

The gateway module 316 is used to receive requests for content data from client modules 302 and to gather retrieved content from content provider modules 320. Each client module 302 can receive content data from any content provider module 320. The billing module 360 generates an invoice, or other billing procedures, and submits the bill or invoice to a user at client module 302. The billing module 360 may also deduct fees incurred by a user from a user's account, in which case the billing module 360 can transmit a statement to the client module, or can mail the statement to the user's address.

Content provider modules 320 post services, goods and/or content data (service information goods and content are referred to generally herein as content data), which can be transmitted to a client module 302. The content data may or may not have a fee or charge associated with it. The gateway module 316 serves to receive a search request from content module 302 and interface with content provider modules 320 such that content-data retrieved from a content provider module 320 is displayed at client module 302. The gateway module 316 has a processor 351 and memory 353.

When content-data retrieved from a content provider module 320 is the type that includes an associated fee, a user at client module 302 can be prompted to authorized payment of the fee prior to receiving the content-data. If the user authorizes payment for the content data, the content-data is transmitted to the client module 302. The client module 302 can then display the content-data or further process it. Such processing can include adding portions, deleting portions, changing the format, storing it to a storage medium or outputting it to a peripheral device, such as a printer. The fees incurred by client module 302 are accumulated in billing module 360. Thus, if the fee for particular content data is two-cents, a two-cent charge will be added to the user's account at billing module 360.

A user can have a pre-paid account with billing module 360, or alternatively, billing module 360 can periodically generate an invoice for each client module. Thus, a user does not have to pay a relatively small fee (e.g., two-cents) each time content-data with an associated fee is retrieved by client module 302. Instead the small fee is either deducted from a user's account, or added to a periodic bill that is sent to the user.

Of course, if the content-data retrieved from content provider modules 320 does not have an associated fee (i.e. it is free content-data), it can be retrieved by client module 302 without charge.

It is also an embodiment of the present invention that a user can store pre-defined settings in client module memory 304. These pre-defined settings allow certain charges for content-data to be accepted without authorization from the user. For example, a user could pre-authorize all charges less than 1-cent to be incurred without authorization at the time the content-data is retrieved.

Also, a user may set the predefined settings to accept all charges within a particular time period. For example, a user could authorize all charges incurred within a particular time-frame to be accepted without prompting the user. Thus, if a user is performing on-line research and wishes to retrieve particular content-data, the fee for that data is pre-authorized provided the research is performed within the time frame.

Also, a user may set the predefined settings to accept all fees incurred from a particular content provider to accept all fees incurred from a particular service/content provider or a class of service/content providers (generally providers). Thus, if a user is retrieving maps, all map data will be downloaded to the user without requiring the user to authorize each map that is retrieved. The providers can be grouped in a preselected manner according to the content and/or service they provide.

For example, a company or organization can define or designate a set of service/content providers and pre-authorize information from the designated providers. This has the advantage that employees or members of the company or organization are permitted to retrieve services/content from the designated providers without interruption or additional authorization. The company or organization can reduce the possibility that employees or members will incur unauthorized charges.

Also, a user may set the pre-defined settings to reject all content-data from particular content providers. This is useful when employees are using an employers workstation and the employer wishes to limit access to designated content providers. This feature is also useful for parents to limit what content their children can retrieve from the Internet.

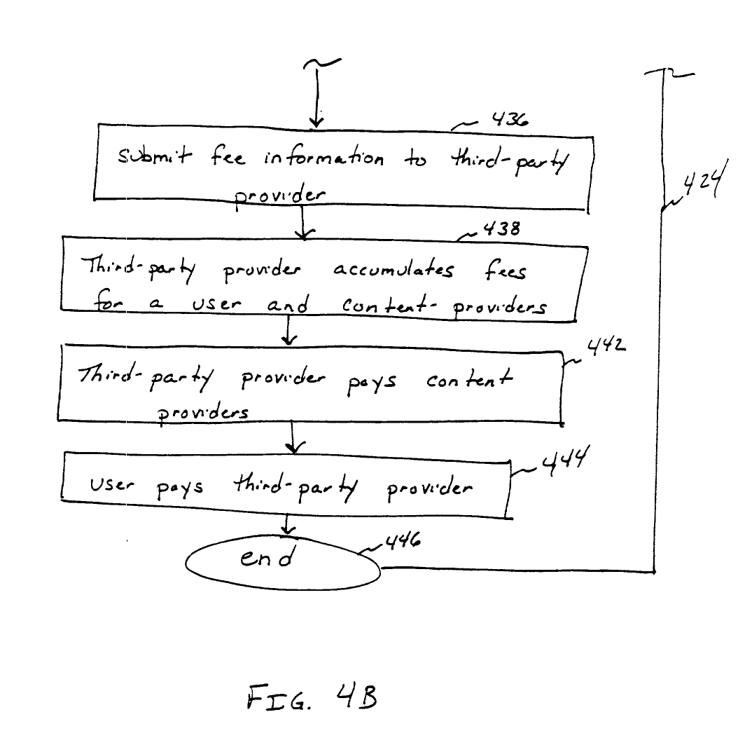

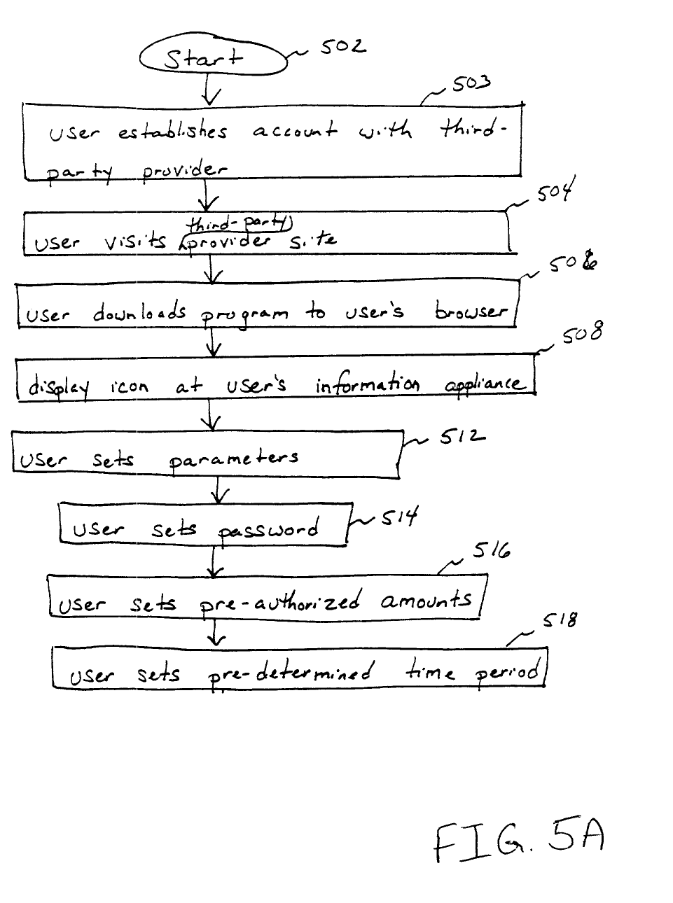

By way of example, an employer can set a time period for the hours of 9 a.m. to 5 p.m. to ensure that work-related charges are pre-authorized. The employer can also set particular web sites so that work-related content data will be pre-authorized. FIGS. 4A and 4B show a flow chart 40 of steps to implement the present invention. This method is suitably stored on a computer-readable medium such as a floppy disk or stored in RAM or ROM. Block 402 is a start block in which the process begins. Block 404 shows that the user's browser, which is typically running as a program application on the client module, or information appliance, described above is integrated with the user defined settings for automatic acceptance of selected charges that relate to content data retrieved from a remote location. Block 406 shows the user establishes a user account with a third party provider. This usually entails the user providing either credit card information, checking account information, or a billing address to a third party so that the third party can send invoices. Dashed line 408 leads to block 412, which shows the user can then receive content from one or more content providers. The content is received based on the user-defined settings and does not require the user to request the content. This is accomplished if the content provider is pushing content to any recipient who will receive it. Pushing data relates to providing “active” information—of a sort identified by the user to be of interest. It is sent to the user directly, rather than appearing as a background or border for other items, and though widely used for advertising, as described herein refers to any information sent in this manner. The content is typically transmitted via Internet, world wide web, or other method of transmitting content from a remote location to a user.

As shown in block 410 a user can request content from a content provider. Block 414 shows the content is reviewed by the user information appliance, or client module, to determine whether or not it is preauthorized. Decision block 416 determines whether or not the content is preauthorized. If the fee is pre-authorized, line 426 leads to block 428, in which the content is displayed to the user. If the fee is not pre-authorized, line 418 leads to block 420 in which the user is prompted for authorization to retrieve content that has not been preauthorized or pre-approved. Decision block 422 determines whether or not authorization is received. If not, line 424 leads to end block 446.

If the user authorizes the retrieval of the content data in block 422, line 430 leads to block 428 and the content data is displayed to the user. In block 436 a third party provider receives the fee information. In block 438 the third party provider accumulates a number of incremental fees for a particular user or for particular content providers, depending on how the fee payment agreement is structured. Block 442 shows a third party provider pays the content providers. Block 444 shows that the user pays the third party provider for the fees incurred by the user retrieving the content data from content providers. Block 446 is an end block.

Alternatively, the amount of the fee can be displayed to the user prior to downloading the content-data to the user who may then decide whether or not to accept the content data. Thus, a user will not be surprised by the amount of the fee associated with particular content data.

In an embodiment in which a particular third party provider makes payment for a plurality of users, the third party provider can either pay each content provider for each user, or alternatively can pay each content provider for the sum of the charges accumulated by the users and then collect the portion incurred by each particular user from that user.

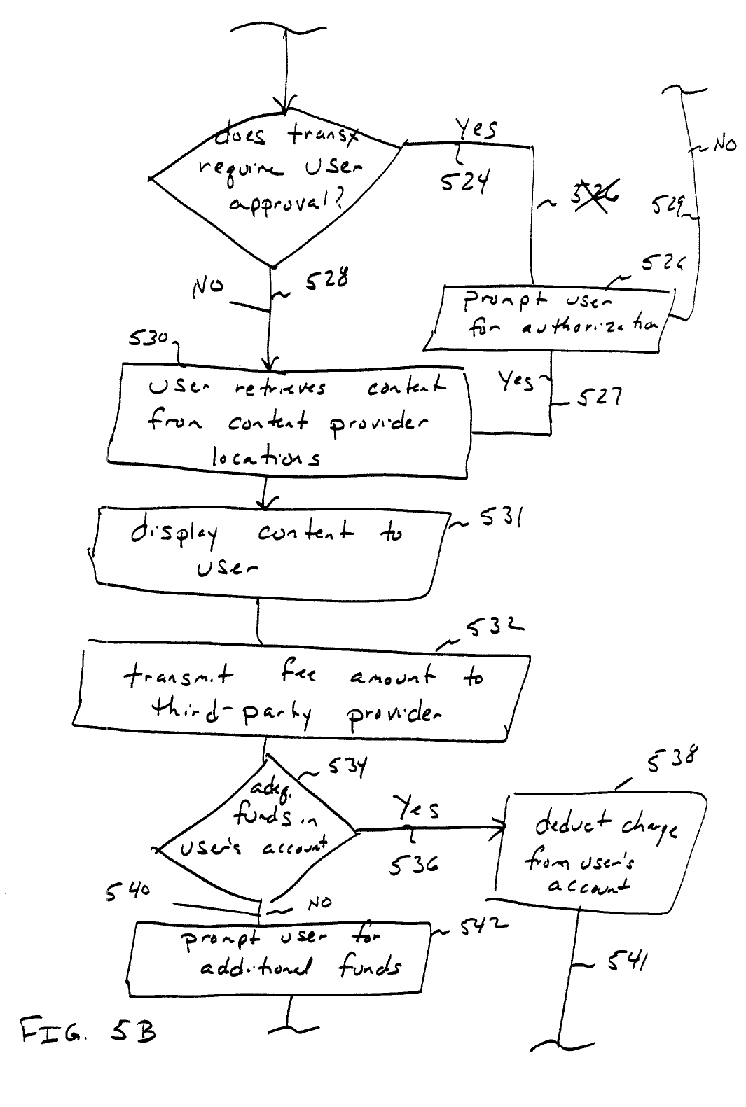

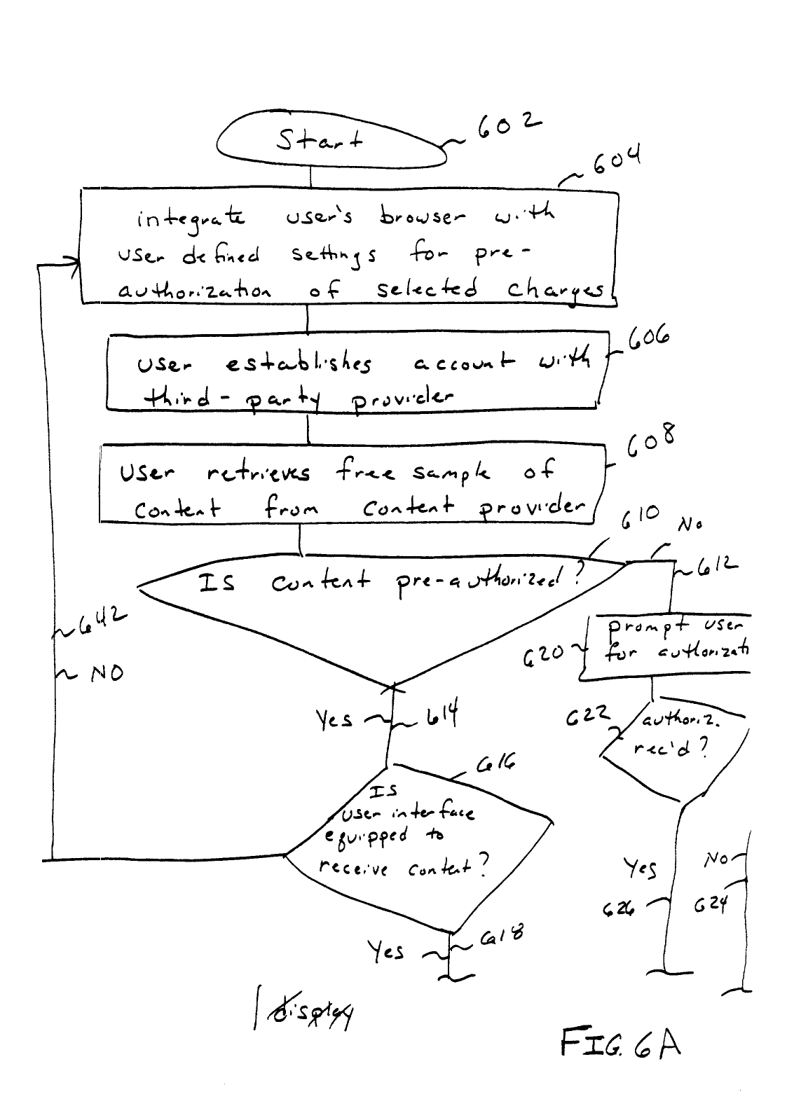

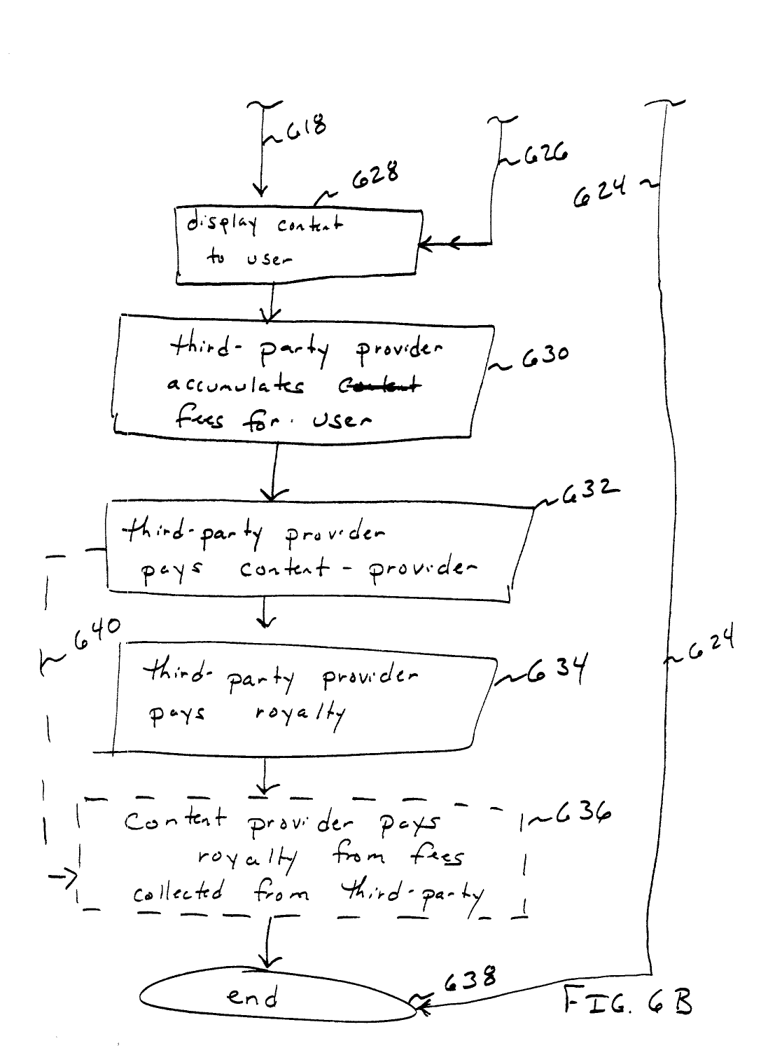

FIGS. 5A-5C show the steps 50 that a user utilizes to pay for content data retrieved from a remote location. Block 502 is a start block. In block 503 a user establishes an account with a third party provider. This can be either a credit account or a debit account or merely address information that the third party can send a monthly bill. Block 504 shows a user visits a third party provider site. Block 506 shows the user can download a program to the user's browser. This program will enable a user's account to be associated with fees the user accumulates. Block 508 shows that a display icon is displayed by the user appliance. Block 512 shows that the user sets parameters for acceptance of particular content data without a prompt requesting authorization. Block 514 shows that the user sets a password to authorize charges that the users wishes to accept, which may or may not be set by the user parameters in block 512.

In block 516, the user selects preauthorized amounts of money that can be used to pay fees for content data that is retrieved. In block 518, a user select a predetermined amount of time in which a particular amount fees may be incurred. Decision block 522 determines whether or not the transaction fee is of a magnitude that requires user approval. If so, line 524 leads block 526 which prompts the user for authorization to incur the fee. If the user authorizes the fee, line 527 leads to block 531 in which the content is displayed to the user. If the user does not authorize the fee, line 529 leads to block 520, which permits the user to retrieve other content data. If the transaction does not require user approval, line 529 leads to block 530, which shows that the user retrieves content data from one or more content provider locations. This is typically done over a network of interconnected computers, such as the Internet, or other means of retrieving content data from a remote location at a client module.

Block 532 shows that the amount of the fee is transmitted to a third party provider. Decision block 534 determines whether or not there is an adequate balance in the user's account. If so, line 536 leads to block 538 in which the amount of the fee is deducted from user's account and line 541 leads to block 546. If there are not adequate funds in the user's account, line 540 leads to block 542 in which the user is prompted to transfer additional funds from another account, or to make a payment to the third party provider. In block 546 third party provider accumulates fees incurred by each user. Then the third party provider can either bill the user, as shown in block 548, or alternatively, the third party provider can debit a user preestablished account as shown by line 550 leading to block 552. Block 554 is an end block.

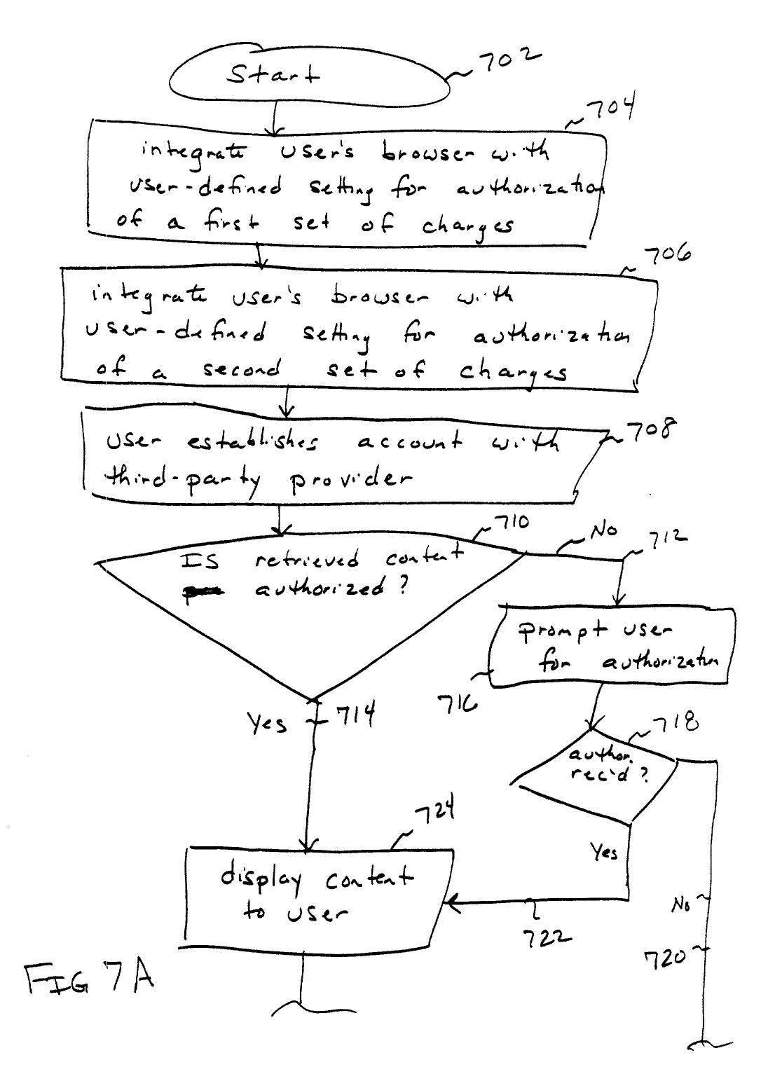

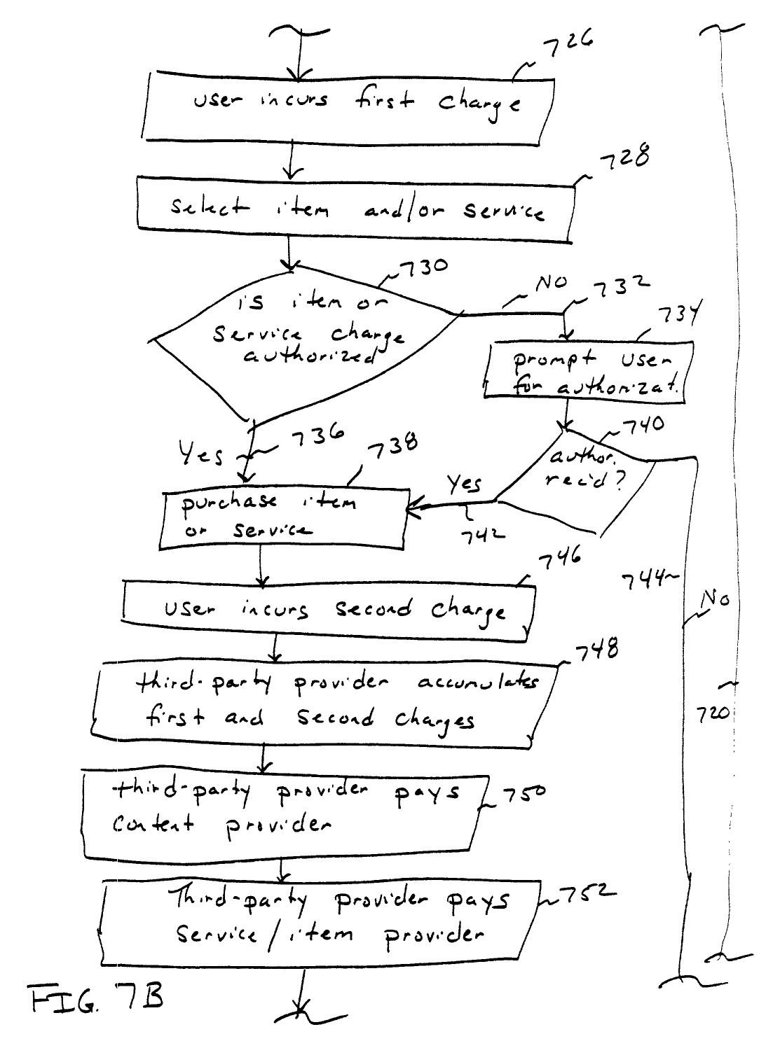

FIGS. 6A and 6B show an embodiment of paying a royalty for retrieved data. This method is typically stored as computer-executable program steps on a computer-readable medium, such as a floppy diskette or read only memory (ROM). The process 60 begins with start block 602. Block 604 shows that the user's browser, which is typically running as a program application is integrated with the user defined settings for automatic acceptance of selected charges that relate to content data retrieved from a remote location. Block 606 shows the user establishes a user account with a third party provider. This usually entails the user providing either credit card information, checking account information, or a billing address to a third party so that the third party can send invoices. Block 608 shows that the user retrieves a free sample of content from a content provider. This free sample is typically an abstract, if the content is text or graphic data and a portion of a song, if the content is sound data.

Decision block 610 determines whether or not the content data is preauthorized. If the content is preauthorized, line 614 leads to block 616, which determines whether the user interface is equipped to receive the particular content. If it is not, line 642 leads to block 604. If the user interface is equipped to receive the content, line 618 leads to block 628 in which the content is displayed to the user.

If decision block 610 determines the content is not preauthorized, line 612 leads to block 620 in which the user is prompted for authorization to retrieve content that has not been preauthorized or pre-approved. Decision block 622 determines whether or not authorization is received. If not, line 624 leads to end block 638.

If the user authorizes the retrieval of the content data in block 622, line 626 leads to block 628 and the content data is displayed to the user. In block 636 a third party provider accumulates the fee information. Block 632 shows the third party provider pays the content providers and block 634 shows that the third party provider pays a royalty to the artist, directly or indirectly. Alternatively, dashed line 640 leads to block 636, which shows that the content provider pays the royalty from the fees collected from the third party provider. Block 638 is an end block.

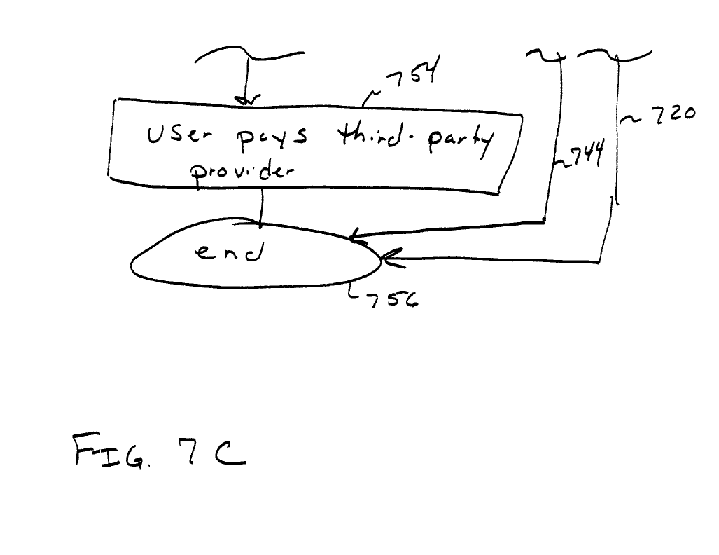

FIGS. 7A-7C show a flowchart 70 of steps to retrieve content data and to purchase an item or service. Start block 702 leads to block 704 in which a user's browser, which is typically running as a program application is integrated with user defined settings for automatic acceptance of a first set of selected charges that relate to content data retrieved from a remote location. Block 706 shows that the user's browser, is integrated with user defined settings for automatic acceptance of a second set of selected charges that relate to items and/or services retrieved from a remote location. Block 708 shows the user establishes a user account with a third party provider. This usually entails the user providing either credit card information, checking account-information, or a billing address to a third party so that the third party can send invoices. Decision block 710 determines whether or not the content data is preauthorized.

If the content is pre-authorized, line 714 leads to block 724 in which the content is displayed to the user.

If decision block 710 determines the content is not preauthorized, line 712 leads to block 716 in which the user is prompted for authorization to retrieve content that has not been preauthorized or pre-approved. Decision block 718 determines whether or not authorization is received. If not, line 720 leads to end block 756.

If the user authorizes the retrieval of the content data in block 71,8, line 722 leads to block 724 and the content data is displayed to the user. In block 726, the user incurs a first charge. This is typically the charge associated with retrieving the content data. In block 728, the user can select an item and/or service, for example a book advertised on a website. Decision block 730 determines if the fee for the item or service exceeds an authorized amount. If the fee is authorized, line 736 leads to block 738, which permits the user to purchase the item and/or service. If the fee for the item and/or service is not authorized, line 732 leads to block 734, in which a user is prompted to authorize the fee. If the user authorizes the fee, line 742 leads to block 738. If the fee is not authorized by the user, line 744 leads to end block 756.

Block 746 shows that the user incurs a charge for the purchase of the item and/or service. Block 748 shows the third party provider accumulates the fees for the content and the item and/or service. Block 750 shows the third party provider pays the content providers and block 752 shows the third party providers pay the item and/or service provider. Block 754 shows that the user pays the third party provider. Block 756 is an end block.

Another method of using the instant invention will now be described, which pertains to a user, who retrieves content data, and a vendor, who providers content data. To purchase user funds, a first-time user visits the third party provider web site and purchases them with a credit-card or debit card. Alternatively, the user may establish a credit agreement directly with the third-party provider. A processing program accompanies the purchase, which, once downloaded, adds a small icon for user purchases of content-data to the user's internet browser; it acts as a display rider for the browser and becomes active only when selected. The rider program allows the user to interact with the third party provider; it “rides” on the browser as an icon in the lower corner, and is installed from CD-ROM or download. Browser manufacturers may also integrate it with their products. After being downloaded, the user may purchase additional funds, verify balance and history, and change settings by clicking on the icon. The third party provider then manages the account.

The user also may set a password and the appropriate level for automatic verification, approving, for example, all charges for under $10 within a session.

Since the funds are not dollar “tokens,” the amounts may be processed in any currency, or converted from one currency to another, as is most convenient for the user. Either the vendor or the third-party provider may offer real-time conversion of currency, so that the user-defined parameters apply anywhere in the world. If, for example, a user has elected to accept all charges of less than 5 cents, all such content may still be accepted, even if the original value is denominated in another currency, such as euros, francs or marks or yen. Since the system also allows purchases of products, either by pre-authorization or by prompt, it may be used to purchase goods in other currencies without the cumbersome additional step of processing credit-card information. Any such purchases are facilitated by the currency conversion as provided above.

A user may also elect to increase the balance in the account periodically through electronic transfer.

The system of the present invention activates when a user initiates a transaction (i.e. retrieves content data from a remote location to a user location) for which a charge or fee will be incurred and paid for by the user funds. The vendor, or content provider, asks the user if he or she wishes to pay the requested amount for the service, and if accepted, proceeds to verification.

Acceptance can be conditional upon entry of a password by the user, but to increase the efficiency of the process—since the entire goal of the present system is to provide appropriate processing—the user may alter the settings on his rider (accessed through the icon on the browser) to automatically approve all transactions of a certain size within a given period. Fees of one dollar, or one cent, or a fraction of a cent, as the user chooses, could all be accepted without a prompt from the user. The user may also choose to have the system alert him or her when funds in the user's account fall below a specified amount.

The present invention also provides for secure on-line transactions using verification. Verification is done in two steps. The first is a simple check with the user information appliance, or client module—if no “cookie” indicates the presence! of user funds, then the user is directed to purchase some—or the provider process on credit. The vendor, or content provider, may allow users without such funds to pay by a traditional method, such as by credit card, but this as cumbersome as described above.

Once a transaction is initiated, the vendor verifies the amount. Verification is made with the provider, via encryption as appropriate, for debit transactions; credit transactions may be verified with either the provider or the vendor, depending on who issues the credit. The advantage of verifying directly online, as opposed to with an account kept on a user's computer, is that it allows the user access to their account from any remote terminal; funds are also more easily kept secure. Once verified, the vendor provides the service to the user.

The third party provider processes charges to a user's account by debiting his or her account. The third party provider also charges the appropriate credit card company when a user purchases additional user funds, in an amount equal to the provided funds less whatever service fee is chosen. For example, for a $101 charge, a user may get $100 in user funds; the credit card company pays $101 to the third party provider, and the provider books $1 as its revenue.

In turn, the third party provider pays each vendor for the sum total of all transactions made with user funds. Payment may be made by any agreed upon method, as with any other service. Doing so on a periodic basis eliminates the obstacle of processing numerous, small transactions. It would, for example, be unduly cumbersome for a company to track and issue ten thousand charges of two cents to a credit card company, and no individual wants such a list on a credit card statement. It also allows for whole-cent accumulation, so that fractional charges may be lumped together. From the user's perspective, navigation through pre-authorized content happens as seamlessly as does retrieval of non-fee based information and services.

One advantage of the present system is that it may also be operated on a credit basis. The third party provider could manage user accounts in this manner. Each user is entitled to a given amount of credit, settled on a monthly basis.

It is also an embodiment of the present invention that credit operation could come from Internet Service Providers or telephone or cable companies, since users already pay on monthly basis to such providers. Some ISPs even have their own, proprietary, dedicated browsers and the present system offers an ideal method for adding such incremental charges to existing bills.

The present system also provides a method for more efficient payment and accounting of royalties. Because the Internet currently lacks a convenient way of accounting for small charges,, most royalties from the publishing world are still issued on a lumpsum basis. This system would allow them to be counted according to each access.

The following examples illustrate the type of commerce that can be implemented by the present system.

For example, a hiker wishes to visit a trail that was described in a local newspaper some months previously. She searches the paper's database and finds the article for 75 cents, paid for by user funds according to the present invention. She gets a topographic map for 50 cents and then goes to the National Park website to download and print a $3 permit for her car, both paid by user funds in her account. Each of these charges goes to her ISP account, previously authorized for payment and settled at the end of the month. She never had to visit another web site to purchase funds. Thus, the present invention allows vendors to provide services for small charges.

Topographic maps are similarly cumbersome to purchase—buying IJSGS maps could conceivably lead to a series of $1 charges, each paid separately, which is cumbersome, at best, with a credit card. Private companies offer groups of maps on CD-ROM and simpler ones online, but they, too have no easy way to charge for detailed ones case-by-case. The present invention enables a user to retrieve maps from a web site and pay for them using user funds as described herein.

A second example is user who is researching a line from a particular poem and finds the full text online, $1.50 is paid from his account, previously established at a third party provider. After processing, the third party provider sends notice to the rider on the user's computer to make his icon “flash” indicating that: his accounts, paid on debit, need replenishing. The service providing the poem also gets paid, for example, eleven cents by the user's funds—from the vendor of the search—and in turn, pays the 1/10th of a cent royalty for the found poem to the publisher and poet.

A third example is when a user is typing a letter to a friend, the user gets a message that tickets for her favorite band have just been released. She gets details of the concert, a photograph from the official fan site, and a digital recording of the concert—all using the present invention. At the end of the day, the last in the month, her account is increased automatically by the amount she chose for electronic transfer.

“Push” technology currently sends targeted emails and sometimes even selected banners, but it has a limited application in short messages. Because there is no simple method cf making small charges, most push-technology either relies on accompanying advertising or is advertising itself. With the present invention, users can choose to be alerted about specific events in sports, television, finance, or anything else, paying automatically and easily for each “hit.”

Official fan sites and news services are some of the most common subscription services, but few offer per-use charges. Users can listen to portions of songs from a digital broadcast from a vendor of music CD's, for example. The present invention makes it convenient to offer consumers complete versions, as well as many other digital samplings, for a nominal fee.

A fourth example is in the purchase of electronic media. A user who wants only one or two tracks from a current music album, can go to a website that sells them as individual MP3 files. The user listens to the free five-second samples, decides whether she likes them, and selects songs she wishes to download. Each costs 20 cents, which she pre-approved, and even as they download, the music site passes on its 1-cent payment to the third-party provider and its 4 cent payment to the recording studio. The studio, in turn, automatically gives a 1/20th of one cent royalty to the recording artist—all amounts accumulated and settled on a periodic basis.

The present invention has been described in detail by way of examples and illustrations for purposes of clarity and understanding, and not to in any way limit the scope of what is claimed. Those skilled in the art will understand that certain changes and modifications may be made without departing from the scope of the invention.

What is claimed is:

1. A method of enabling a user to obtain fee-based content over a network comprising:
setting user-defined parameters to accept all fees below a predetermined amount;
displaying a first portion of content, from a content provider location, at a user location;
determining whether a second portion of content requires payment of a fee by the user;
displaying the second portion of content to the user when the fee for the second portion of content is accepted based on the user-defined parameters; and
accumulating a plurality of fees incurred by the user at a third party provider location,
wherein the third party provider pays the content provider the amount of the fees incurred by the user and the user makes payment to the third party provider on a periodic basis.

2. The method of claim 1, further comprising prompting the user for acceptance of the fee when the fee for the second portion of content exceeds the predetermined amount.

3. A system that enables a user to obtain fee-based content from a remote location comprising:
a client information appliance, adapted to receive user-defined parameters relating to acceptance of fees, the client information appliance adapted to retrieve content from a remote location and display that content to a user at the client information appliance;
a content provider appliance, adapted to provide content to one or more client information appliances,
wherein the client information appliance retrieves a portion of content from a remote location and determines whether additional content is desired such that if a fee for the additional content does not exceed a predetermined amount, the additional content is retrieved; and
a payment appliance, sponsored by a third party provider, the payment appliance adapted to accumulate fees incurred by the user and to remit payment to the content provider and the user pays the third party provider on a periodic basis.

4. The system of claim 3, wherein if the fee for the additional content exceeds the predetermined amount, the user is prompted to accept the fee, and if the user accepts, the additional content is retrieved.

5. A method for enabling a user to access content over a network comprising:
establishing user-defined settings that authorize payment of all fees that do not exceed a predetermined amount;
requesting content from a content provider via the network;
determining whether the content requires payment of a fee by the user;
determining whether payment for the content has been authorized by the user-defined settings, wherein if the payment has been authorized, the user incurs a fee for the content;
displaying the content to the user; and
accumulating, at a third party provider, a plurality of fees,
wherein the third party provider pays the content provider the amount of the accumulated fees.

6. The method of claim 5 further comprising:
accumulating a plurality of fees incurred by a user; and
the user making payment to the third party provider on a periodic basis.

7. The method of claim 5, further comprising integrating the user-defined settings on a browser application.

8. The method of claim 5, further comprising verifying, by the third party provider, the fees incurred by the user.

9. The method of Clam 5, further comprising setting the user-defined settings to accept fees for requested content from particular content providers without prompting the user.

10. The method of claim 5, further comprising setting the user-defined settings to accept a particular quantity of fees within a particular time period.

11. The method of claim 5, further comprising setting the user-defined settings to accept individual fees that do not exceed a particular individual fee threshold.

12. The method of claim 5, further comprising setting the user-defined settings to accept accumulated fees that do not exceed a particular accumulated fee threshold.

13. The method of claim 5, further comprising collecting content from a plurality of content providers as a function of HTML or other tags of each content provider website.

14. The method of claim 5, further comprising establishing the user-defined settings to accept content from selected content providers.

15. The method of claim 5, further comprising displaying content from a content provider when an individual fee does not exceed an individual fee threshold and an accumulated fee does not exceed an accumulated fee threshold, without prompting the user.

16. The method of claim 5, further comprising rejecting content from a content provider based on the type of content.

17. The method of claim 5, further comprising:
displaying a prompt to a user when a fee exceeds the authorized amount; and
inputting either an acceptance or rejection of the fee by the user,
wherein if the user accepts the fee, the content is displayed and the user incurs a fee for the content.

18. The method of claim 5, wherein the network is the Internet.

19. The method of claim 5, further comprising inputting a user-defined password prior to requesting content from the content provider.

20. The method of claim 5, further comprising generating an invoice as a function of fees incurred by a user.

21. The method of claim 5, wherein the third party provider is an Internet Service Provider.

22. The method of claim 5, wherein the third party provider is a financial institution.

23 The method of claim 5, wherein the third party provider is a credit card company.

24. The method of claim 5, further comprising transmitting a message from the third party provider to a user when accumulated fees exceed a predetermined amount.

25. The method of claim 5, further comprising:
storing user account information at a remote location;
storing the user-defined settings at the remote Location; and
enabling a user to access the user account information and user-defined settings from the remote location.

26. The method of claim 5, further comprising providing a connection from a user terminal to a third party provider terminal to enable the user to access their account from a terminal without a processing program associated with the browser.

27. The method of claim 5, further comprising prompting the user to approve a fee for content that has not been authorized by the user.

28. The method of claim 5, further comprising establishing a user credit account with the third party provider in which the accumulated fees incurred by the user are paid by the user to the third party provider on a periodic basis.

29. The method of claim 5, further comprising establishing a user debit account with the third party provider in which the accumulated fees incurred by the user are deducted from a balance paid in advance to the third party provider by the user.

30. The method of claim 5, further comprising:
paying fees, incurred by the user, to the content provider in a first currency; and
paying fees to the third party provider in a second currency.

31. The method of claim 5, wherein the third party provider is another user.

32. The method of claim 29, further comprising generating a signal indicative of a user account balance being 1E!SS than a predetermined amount.

33. A system that enables a user to access fee-based content from a remote location comprising:
a client information appliance, adapted to receive user-defined settings regarding acceptance of fees, the client information appliance adapted to retrieve content to a user from a remote location;
a content provider appliance, sponsored by a content provider, the content provider appliance adapted to provide content to one or more client information appliances,
wherein the client information appliance determines whether the retrieved content requires payment of a fee and if so, determines whether the content has been pre-approved. by user-defined settings; and
a payment appliance adapted to accumulate fees incurred by a user and to remit payment to the content provider based on the accumulated fees.

34. The system of claim 33, wherein the user makes periodic payments to a third party.

35. The system of claim 33, further comprising an Internet browser, that is integrated with the user-defined settings.

36. The system of claim 33, wherein a third party verifies the fees incurred by the user.

37. The system of claim 33, further comprising a memory medium that stores the user-defined settings that enables the user to automatically accept authorized fees.

38. The system of claim 33, wherein the user-defined settings accept a preselected number of fees within a preselected period of time.

39. The system of claim 33, wherein the user-defined settings accept of fees from selected content providers without prompting the user.

40. The system of claim 33, wherein the client information appliance rejects content having a fee that exceeds a predetermined amount.

41. The system of claim 33, wherein the client information appliance rejects content when an accumulated fee exceed a predetermined accumulated fee amount.

42. The system of claim 33, wherein content is collected from a plurality of content providers as a function of HTML or other tags of each content provider website.

43. The system of claim 33, wherein the client information appliance generates a prompt, that is displayed to the user, prior to acceptance of a fee that exceeds a predetermined threshold and the user determines whether the content is accessed.

44. The system of claim 33, wherein the information appliance rejects content from a content provider based on the type of content.

45. The system of claim 33, wherein the user inputs a password in order to accept the fee associated with particular content.

46. The system of claim 33, wherein the network is the Internet.

47. The system of claim 33, wherein the user provides the payment appliance with account information, which the payment appliance utilizes to collect payment for a user's accumulated fees.

48. The system of claim 33, wherein the user pre-pays a pre-selected amount to the third party.

49. The system of claim 33, wherein the payment appliance generates a signal indicative of a user account balance being less than a predetermined amount, and the client information appliance displays the signal.

50. The system of claim 33, wherein the payment appliance generates an invoice for each user appliance and transmits the invoice to an address designated by the user appliance.

51. The system of claim 33, wherein the payment appliance is associated with a financial institution.

52. The system of claim 33, wherein the payment appliance is a client information appliance.

53. The system of claim 33, wherein the payment appliance is associated with an Internet Service Provider.

54. The system of claim 33, wherein a user is able to access their user-account from a remote information appliance.

55. The system of claim 33, wherein the client information appliance operates without a processing program associated with a browser.

56. The system of claim 33, wherein user account information is stored at the payment appliance.

57. The system of claim 33, wherein the payment appliance remits payment to the content provider in a first currency and the user remits payment to the third party in a second currency.

58. A method of providing payment of royalties for fee-based content over a network comprising:
selecting desired content data from a provider;
retrieving a first portion of the selected content data at a user location, the first portion of the selected content data provided without a fee;
determining whether a second portion of the selected content data is desired, the second portion of the selected content data having an associated fee,
wherein when the second portion of the selected content data is retrieved, the associated fee is calculated, a portion of which includes a royalty;
paying the royalty portion of the fee on a periodic: basis; and
paying a content portion of the fee to the content provider on a periodic basis.

59. The method of claim 58, further comprising:
accumulating a plurality of royalty fees;
accumulating a plurality of content fees; and
transmitting payment, from a user, to a third party provider for the accumulated royalty fees and the accumulated content fees.

60. The method according to claim 58 further comprising, setting user-defined parameters that authorize retrieval of content data without prompting the user for acceptance of an associated fee.

61. A system for providing payment of royalties comprising:
a client information appliance, adapted to retrieve content to a user from a remote location;
a content provider appliance, adapted to provide content from a content provider to one or more client information appliances,
wherein the client information appliance retrieves a portion of content from a remote location and determines whether additional content is desired and if so retrieves the additional content; and
a payment appliance, adapted to accumulate fees incurred by a user and to remit payment to the content provider and to remit a royalty payment.

62. The system of claim 61, wherein the client information appliance receives user-defined parameters that determine content data that is retrieved without prompting the user.

63. A method for enabling a user to access content data and purchase items and/or services over a network comprising:
pre-authorizing a first amount for payment of content data by inputting user-defined parameters;
pre-authorizing a second amount for payment of items and/or services by the user-defined parameters;
retrieving content from a content provider, to a user location, via the network;
determining whether payment for the content has been pre-authorized by the user-defined parameters, wherein if the content has been pre-authorized, the user incurs a fee for the content;
displaying content data to the user, the content data including one or more items and/or services;
accumulating a one or more content-related fees incurred by the user at a third party provider;
selecting an item and/or service that has an associated fee; and
determining whether payment for the item and/or service has been pre-authorized by the user-defined parameters, wherein if payment for the item and/or service has been pre-authorized, the user incurs an associated fee,
wherein the third party provider pays the content provider the amount of the accumulated fees and the user makes payment to the third party provider.

64. The method according to claim 63, wherein the user authorizes a first predetermined amount for content data and a second predetermined amount for items and/or services.

65. The method of claim 63, further comprising:
prompting the user to authorize a fee that exceeds the pre-authorized amount for content data; and
prompting the user to authorize a fee that exceeds the pre-authorized amount for items and/or services.

66. A system for enabling a user to access content data and purchase items and/or services over a network comprising:
a client information appliance adapted to receive inputs that pre-authorize a first amount for payment of content data, and receives inputs that pre-authorize a second amount for payment of items and/or services, the client information appliance adapted to retrieve data from a remote location and determine a fee associated with the content and items,
wherein the user selects content, and if the fee for the selected content does not exceed the pre-authorized first amount, the content is displayed at the client information appliance without prompting the user and
wherein the user selects items and/or services, and it the fee for the selected items and/or services does not exceed the pre-authorized first amount, the items arid/or services are purchased without prompting the user;
a payment appliance, sponsored by a third party provider, that accumulates fees associated with content and items and/or services incurred by a user and remits payment to a provider of the content and items and/or services.

67. The system of claim 66 wherein the user pays the third party provider on a periodic basis.
